(19) United States
(12) Patent Application Publication
(10) Pub. No.: US 2020/0398745 A1
(43) Pub. Date: Dec. 24, 2020

(54) VEHICLE TRIM WITH DYNAMIC LIGHTING

(71) Applicant: Sigma International, Livonia, MI (US)

(72) Inventor: Pedro Guillen, Livonia, MI (US)

(73) Assignee: Sigma International, Livonia, MI (US)

(21) Appl. No.: 16/907,840

(22) Filed: Jun. 22, 2020

Related U.S. Application Data
(60) Provisional application No. 62/864,058, filed on Jun. 20, 2019.
(60) Provisional application No. 62/864,054, filed on Jun. 20, 2019.

(51) Int. Cl. B60Q 3/70; B60R 13/02; B60Q 3/54; B60Q 3/80; B60Q 1/00; B60R 16/023; H05B 45/10; H05B 45/20

(52) U.S. Cl. CPC B60Q 3/70; B60R 13/02; B60Q 3/54; B60Q 3/80; B60Q 3/283; B60R 16/0231; H05B 45/10; H05B 45/20; B60Q 1/0023

(57) ABSTRACT

A system is provided for dynamic lighting of vehicle trim, accent components, and vehicle controls in a vehicle. The system includes a set of one or more display elements, one or more sensors, and one or more controllers in electrical communication with the one or more sensors and the one or more display elements. The display elements include lighted vehicle trim, lighted accent components, and lighted vehicle controls. The one or more controllers adjust the one or more display elements in response to readings from the one or more sensors. A method for visual feedback to a driver is also provided in response to information provided by vehicle safety features and vehicle controls.

This application claims priority benefit of U.S. Provisional Application Ser. No. 62/864,058 filed 20 Jun. 2019, the contents of which are hereby incorporated by reference.

### TECHNICAL FIELD

The present invention generally relates to the field of transportation, and more particularly to dynamic lighting of vehicle trim, accent components, and vehicle controls to provide visual feedback.

### BACKGROUND

Today's automotive consumers demand the latest in technology and safety features along with the highest quality exterior and interior trim. Vehicle interiors increasingly have integrated advanced lighting technologies that provide the driver and passenger with a personalized experience, while also enhancing the safety of vehicle occupants.

Modern vehicles are equipped with advanced driver assistance systems (ADAS) that include sensor technology for detecting objects nearby the vehicle. For example, sensors provide information useful for blind spot monitoring, lane departure, adaptive cruise control, back up warning, rear cross path detection, pedestrian detection, and parking assist. Sensor technologies for detecting objects include, radar, light detection and ranging (LiDAR) and surround-view cameras. LiDAR is a distance measurement methodology that uses pulsed laser light reflection to make three-dimensional images of a target. Surround-view cameras are key components in many advanced driver assistance systems (ADAS) that provide a bird's-eye view of a vehicle's surroundings, which improves occupant safety. Examples of ADAS applications that utilize surround-view cameras include lane departure, parking assist, blind side detection, pedestrian detection and adaptive cruise control. As the level of safety features have progressed, the number of ADAS sensors in a car have increased from two or three to over thirty, including forward/rear/side facing cameras, forward-looking radar, and LiDAR.

The sensors used in an ADAS may be connected by a vehicle bus. A vehicle bus is a specialized internal communications network that interconnects components inside a vehicle. Special requirements for vehicle control such as assurance of message delivery, of non-conflicting messages, of minimum time of delivery, of low cost, and of electromagnetic field (EMF) noise resilience, as well as redundant routing and other characteristics mandate the use of specific networking protocols. Protocols include controller area network (CAN) and local interconnect network (LIN).

A LIN is a serial network protocol used for communication between components in vehicles. The network topology of a LIN includes up to 16 nodes (one master and 15 slaves) on a single wire bus that reduces wiring complexity and costs. The LIN protocol specification provides a low-cost, short-distance, and low-speed network. It is noted that while LIN operates under a CAN platform, LIN doesn't require the robust data rate and bandwidth performance, or the higher cost, associated with CAN.

A controller area network (CAN bus) is a robust vehicle bus standard designed to allow microcontrollers and devices to communicate with each other's applications without a host computer. CAN is a message-based protocol that is designed for multiplex electrical wiring within automobiles to save on required wiring and associated weight, but can also be used in many other contexts. For each device the data in a frame is transmitted sequentially but in such a way that if more than one device transmits at the same time the highest priority device is able to continue while the others back off. Frames are received by all devices, including by the transmitting device.

The typical automobile network is broken up into several subnetworks that include body control, powertrain, and multimedia networks. Depending on the speed and cost requirements, either CAN or LIN can be implemented. CAN serves high-speed, error-sensitive needs and operates on a 5-V differential bus. LIN, however, serves low-speed, low-bandwidth requirements on a 12-V single-wire bus.

FIG. 1 depicts a prior art vehicle 10 equipped with an advanced driver assistance system (ADAS) with a set of separate wired sensors 12 that communicate over controller area network (CAN) bus 18 and local interconnect network (LIN) bus 14 via a LIN controller 16 to electronic control units 20. FIG. 2 depicts a prior art vehicle 30 equipped with an advanced driver assistance system (ADAS) with a set of separate wireless sensors 32 and wired sensors 12 that communicate over a CAN bus 18 and LIN bus 14. The electronic control units 20 are equipped with antennas 34 to enable communication with the wireless sensors 32.

Along with advances in vehicle safety system technology there continues to be a need for improved feedback techniques that provide the driver with sensory awareness without distracting the driver or requiring the driver to remove their eyes from the road.

Thus, there exists a need in the art for improved feedback techniques that provide the driver with sensory awareness utilizing dynamic lighting of vehicle trim and accent components that change in response to information provided by vehicle safety features and vehicle controls.

### SUMMARY

A system is provided for dynamic lighting of vehicle trim, accent components, and vehicle controls in a vehicle. The system includes a set of one or more display elements, one or more sensors, and one or more controllers in electrical communication with the one or more sensors and the one or more display elements. The display elements include lighted vehicle trim, lighted accent components, and lighted vehicle controls. The one or more controllers adjust the one or more display elements in response to readings from the one or more sensors.

A method for providing visual feedback to a driver in response to information provided by vehicle safety features and vehicle controls includes providing a set of one or more display elements, providing one or more sensors, and providing one or more controllers in electrical communication with the one or more sensors and the one or more display elements. The display elements include lighted vehicle trim, lighted accent components, and lighted vehicle controls, where the one or more controllers adjust the one or more display elements in response to readings from the one or more sensors.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1 depicts a prior art vehicle equipped with an advanced driver assistance system (ADAS) with wired sensors that communicate over controller area network (CAN) and local interconnect network (LIN) to electronic control units;

FIG. 2 depicts a prior art vehicle equipped with an advanced driver assistance system (ADAS) with wireless and wired sensors that communicate over a CAN and LIN;

FIG. 3 depicts a partial view of a vehicle interior showing vehicle trim and accent components with dynamic lighting that change in response to information provided by vehicle safety features and vehicle controls in accordance with embodiments of the invention;

FIG. 4 is a schematic showing the interconnection between sensor(s), a controller, and trim components with dynamic lighting in accordance with embodiments of the invention; and

FIG. 5 depicts a vehicle equipped with an advanced driver assistance system (ADAS) with wired sensors and wireless sensors that communicate over a CAN and LIN to vehicle trim and accent components with dynamic lighting in response to information provided by vehicle safety features and vehicle controls in accordance with embodiments of the invention.

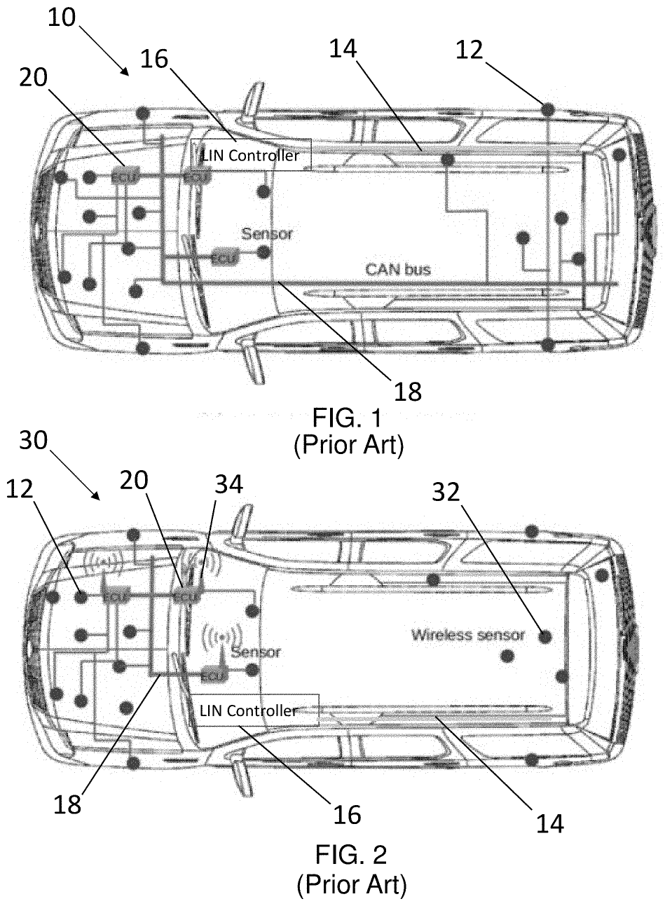

### DETAILED DESCRIPTION

The present invention has utility as a system and method for dynamic lighting of vehicle trim, accent components, and vehicle controls to provide visual feedback to a driver that change in response to information provided by vehicle safety features and vehicle controls.

Embodiments of the vehicle trim, accent components, and vehicle controls include at least one illuminated indicator that a controller automatically alters in appearance based on information from at least one sensor that detects at least one object near the vehicle or a change in vehicle operating parameters. In embodiments of the invention changes in intensity or color of lighting of vehicle trim, accent components, and vehicle controls may be used in connection with blind spot monitoring, lane departure, adaptive cruise control, back up warning, rear cross path detection, pedestrian detection, and parking assist. In embodiments of the invention the illuminating element is a light emitting diode (LED).

In a non-limiting example embodiment, a controller causes a color of light that illuminates vehicle trim, accent components, and vehicle controls to change as the distance between the vehicle and another object changes. The colors correspond to the distance between the vehicle and an object in a manner that alerts a driver to the change in relative spacing. For example, as another vehicle approaches, the controller causes the light to change from one color to a different, more noticeable color. By way of example, multi-color LEDs are provided that can provide total emissions of white, red, yellow, or blue. In a further inventive embodiment, the intensity of light from the vehicle trim changes with respect to a vehicle operating parameter or driver action. In non-limiting examples, an amount of visible light changes as the distance between the vehicle and another object changes, or as the vehicle departs from a lane. For example, as another vehicle approaches the light becomes brighter or a larger area of the indicator is illuminated. In a specific inventive embodiment, the amount of visual illumination of the light from the vehicle trim, accent components, and vehicle controls varies between more than 0 and 54 Candelas. For the purposes of the present invention, brightness is measured at a distance of 30 cm from the light. It is appreciated that brightness must be increased during daytime operation to render the invention detectable by the unaided, normal human eye of a user.

The present invention will now be described with reference to the following embodiments. As is apparent by these descriptions, this invention can be embodied in different forms and should not be construed as limited to the embodiments set forth herein. For example, features illustrated with respect to one embodiment can be incorporated into other embodiments, and features illustrated with respect to a particular embodiment may be deleted from that embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations and variations thereof.

It is to be understood that in instances where a range of values are provided that the range is intended to encompass not only the end point values of the range but also intermediate values of the range as explicitly being included within the range and varying by the last significant figure in the range. By way of example, a recited range from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also, as used herein, “and/or” refers to and encompasses any and all possible combinations of one or more of the associated listed items, as well as the lack of combinations when interpreted in the alternative (“or”).

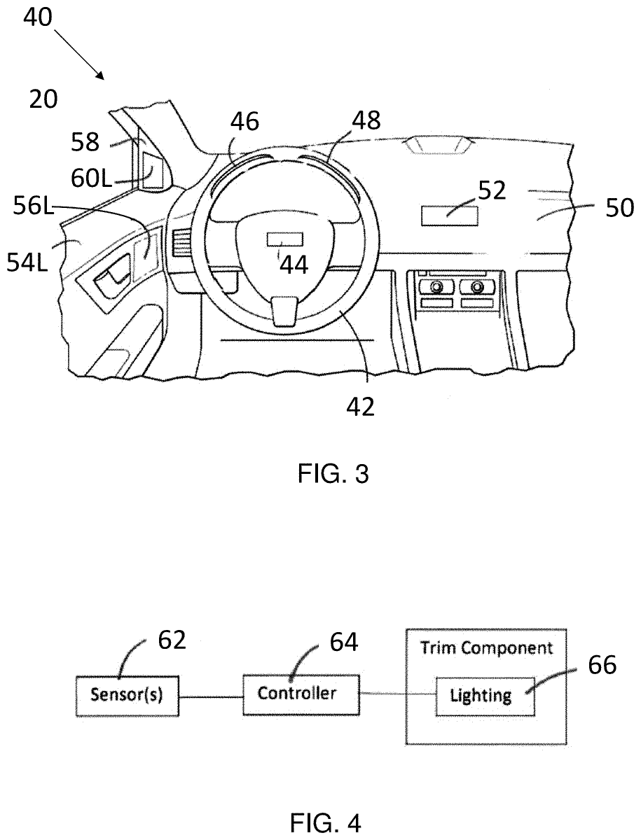

With reference now to the figures, FIG. 3 illustrates a vehicle interior 20 which includes several trim components including many indicators that can be selectively illuminated based on the required feedback to the driver or passenger. As shown, the vehicle interior 40 has a steering wheel 42 that includes lighted indicators including an airbag cover lighted indicator 44, and left and right steering wheel indicators 46 and 48, respectively. A dashboard 50 includes at least one visual indicator 52. A driver door 54L includes a door indicator 56L and an A-pillar trim piece 58 includes an indicator 60L that may be related to blind spot notification.

FIG. 4 is a simplified schematic showing the interconnection between sensor(s) 62, a controller 64, and trim components with dynamic lighting 66. At least one sensor 62 detects objects near the vehicle using known sensing technology, such as surround-view cameras, radar, LiDAR, or ultrasound. The sensor 62 provides information to a controller 64 that is configured to determine at least one characteristic of the detected object or vehicle operating parameter. The controller 64 controls lighting 66 of any or all of the trim components/indicators based on the characteristic of the object or vehicle operating parameter. The controller 64 causes the appearance of the trim component(s)/indicator(s) to change as the characteristic changes.

For example, as the distance between the vehicle and an object changes or the vehicle leaves a lane without using a turn signal, the controller 64 causes the appearance of the trim components/indicator(s) 66 to change. The different appearance provides a visible indication to the driver regarding the changing distance or vehicle control issue. The controller 64 causes a light color visible on the indicator(s) to change as the object approaches or moves further away from the vehicle. At a certain distance, the indicator(s) 66 may be lit and green. As the object approaches the vehicle or the vehicle approaches the object, the color changes to yellow and as they move even closer the color changes to red.

Alternatively, in specific inventive embodiments, the intensity of illumination of the indicator may be varied. These changes signify the shortening distance between the object and the vehicle in an easily understandable, visible manner. For example, the controller 64 changes the appearance of the indicator(s) by causing the lighting 66 to be brighter or dimmer based on different characteristics of a detected object. As an object, such as another vehicle, approaches the vehicle the lighting 66 brightens or intensifies. In some inventive embodiments may further include changing both the color and the brightness or intensity of the light as the characteristic of the detected object or vehicle parameter changes.

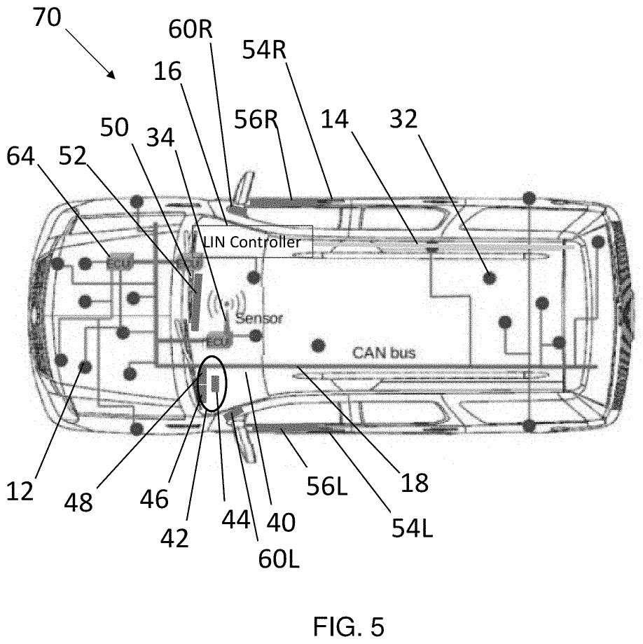

FIG. 5 depicts an inventive embodiment of an overall system in a vehicle 70 equipped with an advanced driver assistance system (ADAS) with wired sensors 12 and wireless sensors 32 that communicate over a CAN 18 and LIN 14 to vehicle trim and accent components with dynamic lighting in response to information provided by vehicle safety features and vehicle controls. As shown some of the electronic control units 64 are equipped with antennas 34 to enable communication with the wireless sensors 32.

The vehicle 70 has an interior 40 as shown in FIG. 3 that has a steering wheel 42 that includes dynamic lighted indicators including an airbag cover lighted indicator 44, and left and right steering wheel indicators 46 and 48, respectively. A dashboard 50 includes at least one visual indicator 52. A driver door 54L includes a door indicator 56L and an A-pillar trim piece 58 includes an indicator 60L that may be related to blind spot notification. The passenger door 54R includes a door indicator 56R and an A-pillar trim piece 58 includes an indicator 60R that may be related to blind spot notification.

### OTHER EMBODIMENTS

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A system for dynamic lighting of vehicle trim, accent components, and vehicle controls in a vehicle comprises:
a set of one or more display elements, said display elements comprising lighted vehicle trim, lighted accent components, and lighted vehicle controls;
one or more sensors; and
one or more controllers in electrical communication with said one or more sensors and said one or more display elements, where the one or more controllers adjust said one or more display elements in response to readings from said one or more sensors.

2. The system of claim 1 wherein the adjustment is made in response to the proximity of an object to the vehicle

3. The system of claim 1 wherein the adjustment of said one or more display elements comprises a color change.

4. The system of claim 1 wherein the adjustment of said one or more display elements comprises a change in the intensity of illumination.

5. The system of claim 4 wherein the change in illumination varies between more than 0 and 54 candelas.

6. The system of claim 1 wherein the adjustment of said one or more display elements comprises a change in both color and in the intensity of illumination.

7. The system of claim 1 wherein said one or more display elements comprise one or more light emitting diodes (LED).

8. The system of claim 1 wherein said one or more sensors comprise at least one of surround-view cameras, radar, light detection and ranging (LiDAR), or ultrasound.

9. The system of claim 1 wherein said one or more sensors comprise wired sensors, wireless sensors, or a combination thereof.

10. The system of claim 1 wherein said one or more controllers are in electrical communication with said one or more sensors and said one or more display elements via at least one of a controller area network (CAN) or a local interconnect network (LIN).

11. The system of claim 1 wherein said system comprises an advanced driver assistance system (ADAS).

12. The system of claim 11 wherein adjustment of said one or more display elements is in connection to one or more of blind spot monitoring, lane departure, adaptive cruise control, back up warning, rear cross path detection, pedestrian detection, or parking assist.

13. The system of claim 1 wherein said set of one or more display elements are positioned in the interior of the vehicle.

14. The system of claim 13 wherein said set of one or more display elements comprise at least one of an airbag cover lighted indicator, a set of left and right steering wheel indicators, a dashboard indicator, a driver door indicator, a passenger door indicator, and a set of A-pillar trim piece indicators.

15. A method for providing visual feedback to a driver in response to information provided by vehicle safety features and vehicle controls comprising:
providing a set of one or more display elements, said display elements comprising lighted vehicle trim, lighted accent components, and lighted vehicle controls;
providing one or more sensors; and
providing one or more controllers in electrical communication with said one or more sensors and said one or more display elements, where the one or more controllers adjust said one or more display elements in response to readings from said one or more sensors.

16. The method of claim 1 wherein the adjustment is made in response to the proximity of an object to the vehicle

17. The method of claim 1 wherein the adjustment of said one or more display elements comprises a color change.

18. The method of claim 1 wherein the adjustment of said one or more display elements comprises a change in the intensity of illumination.

19. The method of claim 18 wherein the change in illumination varies between 0 and 2 Candelas.

20. The method of claim 18 wherein the adjustment of said one or more display elements comprises a change in both color and in the intensity of illumination.
